(19) United States
(12) Patent Application Publication
(10) Pub. No.: US 2011/0025700 A1
(43) Pub. Date: Feb. 3, 2011

(54) Using a Texture Unit for General Purpose Computing

(76) Inventors: Victor W. Lee, Santa Clara, CA (US); Mikhail Smelyanskiy, San Francisco, CA (US); Yen-Kuang Chen, Cupertino, CA (US); Jatin Chhugani, Santa Clara, CA (US); Jose Gonzalez, Barcelona (ES); Changkyu Kim, San Jose, CA (US); Ganesh S. Dasika, Ann Arbor, MI (US)

Correspondence Address: TROP, PRUNER & HU, P.C., 1616 S. VOSS RD., SUITE 750, HOUSTON, TX, 77057-2631, US

(21) Appl. No.: 12/512,284

(22) Filed: Jul. 30, 2009

(51) Int. Cl. G09G 5/00

(52) U.S. Cl. 345/586; 345/610

(57) ABSTRACT

An interpolation unit, such as may be found in a texture unit or texture sampler, may be used utilized to perform general purpose mathematical computations such as dot products. This enables some general purpose computations and operations to be offloaded from a central processing unit to an interpolation unit. The interpolation unit may use linear interpolators in order to perform the dot product calculations.

### BACKGROUND

This relates generally to graphics processing and, particularly, to the texture unit of a graphics processor.

A graphics processor is a dedicated processor that generally handles processing tasks associated with the display of images. A graphics processor may include a number of specialized function units, including a texture unit. A texture unit performs texture operations including texture decompression and anisotropic filtering.

A texture sampler is a special type of texture unit that optimizes texture filtering and performs texture filtering faster than a general purpose processor.

The texture unit may do filtering using linear interpolation units. In addition, other interpolation units, including bi-linear and tri-linear interpolation units, may be available.

### BRIEF DESCRIPTION OF THE DRAWINGS

FIG. 1 is a schematic depiction of a texture unit according to one embodiment;

FIG. 2 is a schematic depiction of one embodiment of the present invention;

FIG. 3 is a depiction of a texture unit including programmable linear interpolation units for performing dot products in accordance with one embodiment;

FIG. 4 is a flow chart for one embodiment of the present invention; and

FIG. 5 shows an example of a convolution according to one embodiment.

### DETAILED DESCRIPTION

In accordance with some embodiments, a texture unit, such as a texture sampler, may be utilized to perform mathematical calculations and, particularly, in some embodiments, the calculation of dot products. These tasks may be offloaded from a central processing unit when the graphics processing unit's texture unit (a texture sampler) is not otherwise engaged. Thus, processing efficiency may be improved in some embodiments. In addition, in some cases, the calculation of dot products and convolutions can be done using available capabilities of existing texture units in the form of linear interpolation, bi-linear interpolation, and tri-linear interpolation filtering units.

Texture mapping is a computationally intense task performed by dedicated hardware in a graphics processor. A number of general purpose computing tasks, such as the determination of a two-dimensional convolution for image processing, matrix-matrix multiplication, and two-dimensional lattice computation for finance applications must normally be completed using the general purpose processing unit, even if the texture unit remains idle. However, a texture unit may be adapted to perform dot product calculations, offloaded from the central processing unit when the texture unit is otherwise idle.

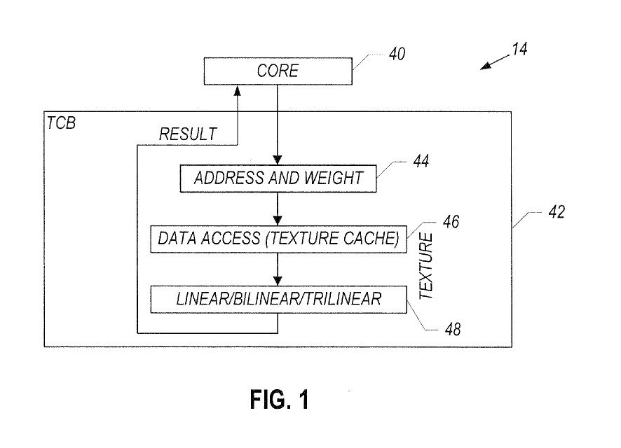

Referring to FIG. 1, a texture unit core 40 of an interpolation unit 14 receives a texture request via a texture control block 42. The texture control block 42 may include a pointer to texture surfaces, the width and height of the texture surfaces, the texture coordinates (u, v) for n pixels to be textured, the type of filtering operation to be performed, such as linear, bi-linear, or tri-linear, and the texture filter results.

An address generation stage 44 computes addresses of all the texels used by a given filtering operation. The coordinates u and v of the pertinent pixel are passed in normalized form between 0.0 and 1.0. They are unnormalized by multiplying them by a surface dimension. For example, u becomes i.bu, where i is an integer and bu is a fraction. The integer portion is used to produce nearest neighbors. In the case of bi-linear interpolation, there are four neighbors: (i,j) (i+1,j) (i,j+1), (i+1,j+1). In tri-linear filtering operations there are eight neighbors. The fractional part may be used to calculate the weights which may be used when blending the neighboring pixels.

A data access stage 46 accesses all of the necessary neighboring pixels. This stage may have a relatively long latency, first in, first out buffer, to tolerate long latencies.

The filtering stage 48 performs linear, bi-linear, or tri-linear interpolation of the neighbor pixels. The filtering stage is implemented in a tree of linear interpolation filters with three possible coefficient inputs. The filtering unit may contain a number of linear interpolators that are connected in a tree fashion to perform bi-linear and tri-linear filtering.

Bi-linear filtering involves three linear interpolations on two levels. Tri-linear filtering involves seven linear interpolations on three levels. For bi-linear filtering, only one coefficient (bu) is allowed for the first level and a second coefficient (bd) is used for a second level. With tri-linear filtering, coefficients used for the first two levels as on the bi-linear operations and the third coefficient (bw) is used for the third level.

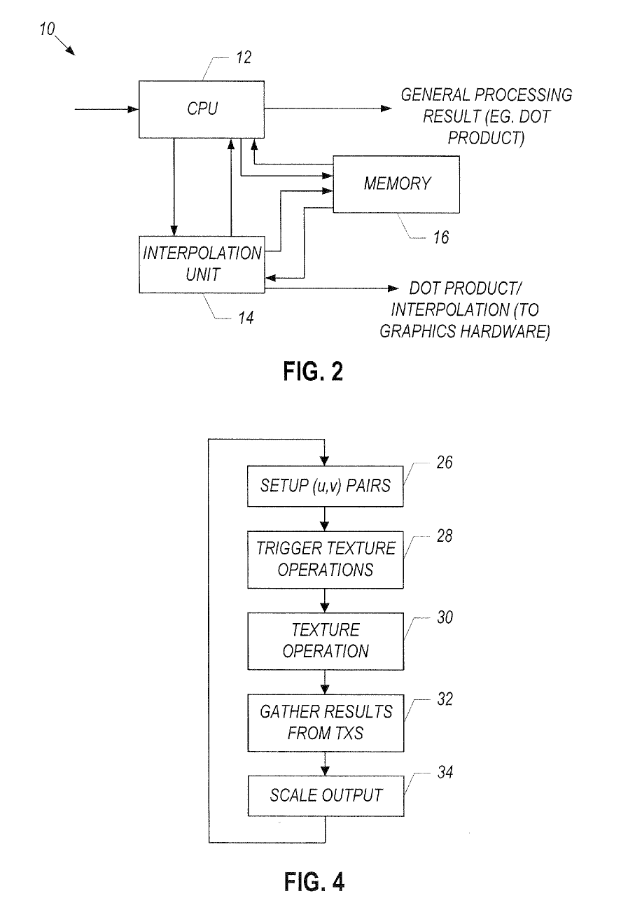

Thus, referring to FIG. 2, a general processing unit 12 may be coupled to a dedicated interpolation unit 14. The general purpose processing unit may be a central processing unit having one or more cores, a controller, or a digital signal processor, to mention a few examples. In one embodiment, the interpolation unit may be a texture unit, such as a texture sampler, of a graphics processing unit. A dedicated interpolation unit is hardware or software designed for interpolation using linear interpolation. Both the central processing unit 12 and the interpolation unit 14 may be coupled to a memory 16. The output of the central processing unit may include general processing results, such as dot products.

When the central processing unit 12 is otherwise occupied and the interpolation unit 14 is available, the interpolation unit 14 may use its linear interpolation capabilities to perform dot products operations offloaded from the central processing unit 12 to the interpolation unit 14. Thus, the interpolation unit 14, generally dedicated to graphics functions, such as filtering and interpolation, may use its available linear interpolation capability to perform dot product calculations for the central processing unit.

Referring to FIG. 4, originally, the central processing unit 12 sets up the (u, v) pairs for each pixel, as indicated in block 26. Then the central processing unit triggers the texture operations, as indicated in block 28. A texture operation 30 is performed in the interpolation unit 14. Then the central processing unit gathers the results from the interpolation unit, as indicated in block 32, and scales the output, as indicated in block 34.

For ease in programming, a library function or application program interface (API) may be used to simplify the programming of the texture unit (TXS) to perform general purpose processing. Two functions related to the general dot product computation of a two input vector A and B (i.e., A dot B=A0*B0+A1*B1+ . . . +A*Bn) is:

TXS-DP (int m, int n, float *A, Type *W, mast type_t * Mask, type * result):
where m and n are the dimension of the dot product (DP), A is one of the vectors to be multiplied, W points to the vector of the coefficient normalized from the input vector B. A mask is used to handle negative or degenerated coefficients, as explained herein. The result of the dot product operation is returned in the result. The vector A, the vector B and the result can be different types of vectors, including char, int, or float. While the majority of the dot product operation may be performed in the texture unit, some parts may be performed on the central processing unit.

As part of the computation, the vector B may be normalized. A high level function or API may be utilized to facilitate programming:

TXS_LerpCoefTransform (int m, int n, float *B, float *W, mask type_+*mask):
where B is the input vector, W is the normalized vector used in the call to the texture unit. The function may also generate a mask to handle negative or generated coefficients, with the mask being another input to the texture unit call.

An example of the determination of dot products using linear interpolation capabilities is a two-dimensional dot product. However, the present invention is not so limited. The way that a dot product calculation may be performed using linear interpolation capabilities is as follows:

A simple 2-element dot-product has the form:

$$P \cdot w = {\sum }_{i = 0}^{1} {P}_{i} \times {w}_{i}$$

If we expand this equation for the dot product (DP),

DP=P0*w0+P1*w1=(w0+w1)*lerp(w0/(w0+w1), P0, P1) (Formula 1).

This is readily mappable to the linear filter provided by the texture sampler. The processor core needs to provide the (u, v) coordinates to generate the w0/(w0+w1) coefficient correctly. Scaling by (w0+w1) factor can happen either on the processor core, or on the interpolation unit or texture sampler if they have support for such scaling operation.

Similarly, we can map 4- and 8-element dot-products to the bilinear and trilinear filter operation. While there are many ways to do this mapping, we describe two preferred embodiments of such mapping. In the first preferred embodiment, 4-element dot product can be expressed using bilinear filtering as follows: DP0₀₀₋₁₁=w00*P00+w01*P01+w10*P10+w11*P11=s*BF(u, v, P00, P01, P10, P11)+d* P10, where u=w01/(w01+w00), v=w10/(w00+w10), s=((w00+w01)*(w00+w10))/(w00) and d=(w00*w11−w01*w10)/((w00+w01)*(w00+w10)).

In the second preferred embodiment, 4-element dot product is mapped to 2-level tree of lerps by recursively applying formula 1 to each pair of dot products (1-level of lerps) and then to the resulting sum (second level of lerps, in the following way:

```
DP0₀₀₋₁₁ = w00*P00+w01*P01+w10*P10+w11*P11=
(w00+w01)*lerp(w00/(w00+w01), P00, P01)+
(w10+w11)*lerp(w10/(w10+w11), P10, P11)=
(w00+w01+w10+w11) *
    lerp((w10+w11)/(w00+w01+w10+w11),
        lerp(w01/(w00+w01), P00, P01),
        lerp(w11/(w10+w11), P10, P11)
      )
```

For larger dot products there are several ways to do the mapping. If we have higher order interpolation units, such as trilinear, or even quadlinear, both preferred embodiments could be re-written more compactly to take advantage of such units, to do 8-element, or even 16-element dot product. For example, 8-element dot product for 2×4 quandrant can be represented as 3-level tree of lerps by recursively applying formula 1.

In cases where the size of the product which can be performed in hardware is less than size of the required dot product operation, we partition the full dot product into the sum of smaller dot products, such that each such dot product is done on hardware (for example, using one of the two preferred embodiments described above), and use CPU 12 or texture sampler to add them all up.

For example, following chart illustrates how to compute a 16-element dot product, when only bilinear unit to do 4-element dot product is available. We use a first preferred embodiment to do the 4 element dot product.

| | | | |
|---|---|---|---|
| P00 | P01 | P02 | P03 |
| P10 | P11 | P12 | P13 |
| P20 | P21 | P22 | P23 |
| P30 | P31 | P32 | P33 |

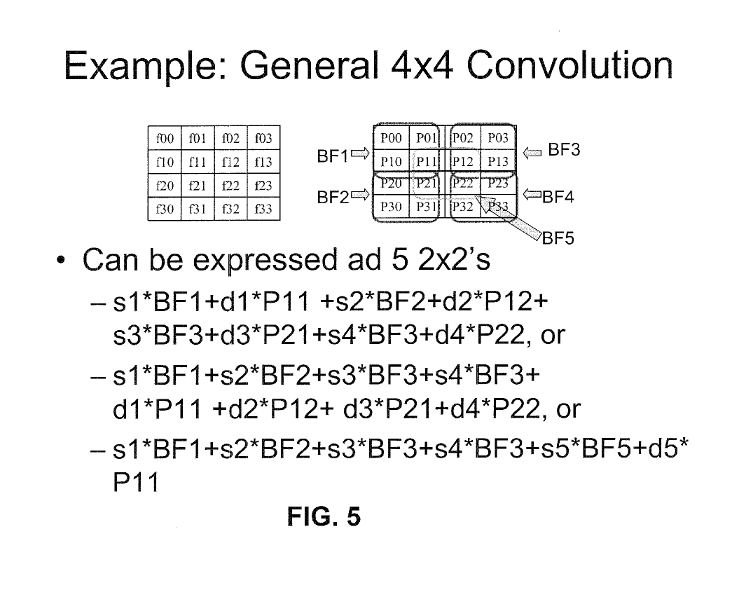

Mathematically, a 16-element dot product can be expressed as: s1*BF1+s2*BF2+s3*BF3+s4*BF4+s5*BF5+s6*P11, where, referring to FIG. 5, BF1 is bilinear filtering operation for upper left quadrant (P00, P01, P10, P11), BP2 is the same for lower left quadrant (P20, P21, P30, P31), BF3 is the same for the upper right quadrant (P02, P03, P12, P13), BF4 is the same for lower right quadrant (P22, P23, P32, P33), and BF5 is the center quadrant (P11, P12, P21, P32).

It is not desirable to deal with linear interpolation coefficients that are either not defined or negative. For example, suppose that a 1×2 dot product is P0-P1. In this case, the linear interpolation coefficient is not defined due to division by zero. Another example is the dot product P0−2*P1. In this case, the coefficient is negative (1/(−1)). In this case, passing a negative coefficient to the linear interpolation unit does not work due to the fact that the linear interpolation unit only expects positive coefficients.

To avoid both of these constraints, whenever the dot product coefficient is negative, its sign may be changed. To compensate, the sign of the corresponding P value may be reversed during the filtering operation. To compensate for the sign change, a control mask is passed for each of the texels with a negative coefficient to the texture control block. The mask being zero means that the corresponding coefficient is positive. A mask of one means that the corresponding coefficient is negative and signals the apparatus to reverse the sign of the texel data. For example, in the case of P0−2*P1, change (−2) to 2 to get P0+2*P1. This results in the linear interpolation computation: 3*lerp(⅓, P0, −P1), where lerp is the linear interpolation. Note how the sign of P1 is flipped to compensate for the sign change in its coefficient.

Thus, it is possible to map 2, 4, and 8 element dot products into a maximum of three levels of linear interpolation.

For any application that involves texture unit kernels, such as n-element dot products, one can rewrite it using the available library of linear interpolation calls. The main code is still executed on the general purpose processor core and the library functions are partially executed on the partially core and partially executed on the texture unit. The part of the library function that executes on the processor core involves setting up and initiating the communication between the core and the texture unit and accumulating immediate results for final output.

These essentially are the overhead related to the texture unit scheme. The performance gain from the algorithm may be offset by these offsets. If the texture unit is implemented in dedicated hardware, these overheads may be reduced and may achieve higher performance, in some embodiments.

One application of some embodiments is the determination of two-dimensional convolutions. This is a common operation in image processing and many scientific applications. A two-dimensional convolution may be implemented using two texture unit (TXS) functions, including a transform that transforms a convolution filter coefficient into the required normalized filter values and a function that performs the actual convolution. For an input image of size k×k and m×n filter, the two-dimensional kernel is as follows:

```
Input: InputImage[i][j] of size N x N
Filter: Filter[m][n] of size k x k
TXS_LerpCoeffTransform(k, k, &Filter[0][0],
&Filter_Lerp[0][0], &mask[0][0]);
for(i=0; i < N; i++)
    for(j=0; j < N; j++) {
        TXS_DP(k, k, &Filter_Lerp[0][0],
&InputImage[i][j], &mask[0][0], &result);
        OutputImage[i][j] = result;
    }
```

A call to the transform takes original filter coefficients and converts them into linear interpolation coefficient form. For each image pixel, input image [i] [j], convolution is performed using the transformed filter_lerp.

As the dot product is offloaded to the texture unit, the processor core is now free to perform other operations.

Note that a call to setup coefficients TXS_LerpCoeffTransform to transform a convolution filter coefficient into the normalized filter values introduces some overhead. However this overhead is amortized over multiple usages of such values, which is certainly the case with dot product. It is also possible that there may be a more general filtering which does not use transformation of such coefficients, in which case there will be no call to TXS_LerpCoeffTransform, and hence no further overhead.

Another example is matrix multiplication. Again, two graphic texture unit functions are used, including the transform function that transfers a row of one matrix into a texture unit required coefficient format and the function that performs the dot product to a column of another matrix. The following code may perform the calculation C=A*B, where matrices A, B, and C are square matrices of dimension N. These matrices may be of any type including char, short, int, or float.

```
for(row=0; row < N; row++) {
    TXS_LerpCoeffTransform(1, N, A[row], RowAlerp, mask);
    for(column=0; column < N; column+=4) {
        TXS_DP(1, N, RowAlerp, &B[0][column], mask,
        &result); for(c=0; c < 4; c++)
            C[row][column+c]=result[c]
    }
}
```

Each row of the matrix A may be transformed into the vector of the linear interpolation coefficients, RowALerp. RowALerp is then used to perform a dot product with every column of the matrix B, B[*] [column]. The result of a single call to the dot product function is four elements of C. Each call to the dot product function computes four consecutive elements of C: C[row] [column], C[row] [column+1], C[row] [column+2], C[row] [column+3].

Still another example is the determination of the two-dimensional binomial tree lattice. This may be used in computational finance to numerically solve a partial differential equation that describes market dynamics over time. The two-dimensional lattice shows the value of a tradable element whose value is dependent on the price of two random variables, such as a bond in a foreign currency whose value is dependent on the bond value in the foreign exchange rate. At each time step, the two-dimensional lattice may be traversed with a 2×2 window using four neighboring cells to computer the expected price in the next time step:

bCurr[ji] [j2]=P1*vPrev[j1+1] [j2+1]+P2*vPrev[j1+1] [j2]+P3*vPrev[j1] [j2+1]+P4*vPrev[j1] [j2].

A typical problem starts with 2000×2000 lattice. With such a lattice, there are 1999×1999 2×2 windows. The 1999×1999 set of results forms the lattice of the next iteration. Computation may continue until there is one item left in the lattice.

P1, P2, P3, and P4 are constants throughout the iterations and can be computed in advance. They are positive and non-zero for all practical problem parameters. The basic operation with the 2×2 window reduces to a weighted sum computation with constant coefficients that match well into the linear interpolation computation on the texture sampler.

In some embodiments, the operation that performs the dot product may be implemented in software or firmware. In such cases, a computer may be controlled by computer executable instructions stored on a computer readable medium such as a semiconductory memory. In other embodiments, the operations may be implemented entirely in hardware and, in still other cases, combinations of hardware and software may be utilized.

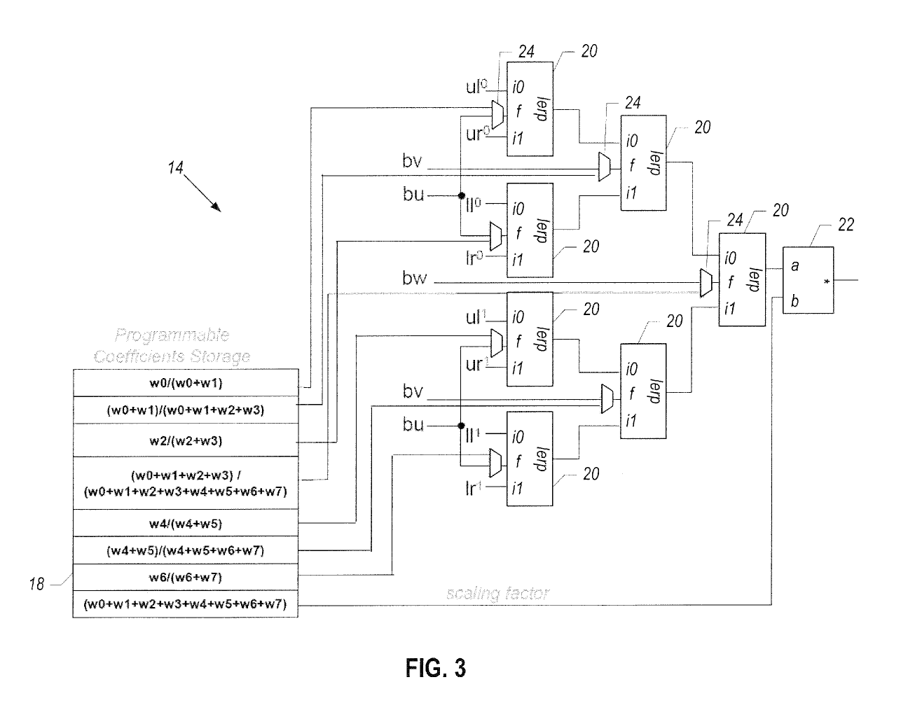

Referring to FIG. 3, independent inputs may be provided to each linear interpolator (Lerp) 20 in a linear interpolator tree to effectively compute a 2, 4, or 8 element dot products with the available linear interpolation functions, without any spillover computation in some embodiments. The additional storage needs may be small in some cases, such as eight 32 bit locations for 32 bytes total. Additionally, a 32 bit multiplier 22 may be used. A programmable coefficient storage 18 may store the coefficients that are needed by the linear interpolators and provide them through a multiplexer 24 to each linear interpolator 20. In addition, a scaling factor may be provided to one input of the multiplier 22.

In some embodiments, the linear interpolator coefficients 18 may be programmed directly by a programmer. Coefficients 18 are derived for 8-element dot product using recursive application of formula 1. To save space, we show the final result below: coefficients 18 come from coefficients of the lerps below:

```
w0*P0+w1*P1+w2*P2+w3*P3+w4*P4+w5*P5+w6*P6+w7*P7=
    (w0+w1+w2+w3+w4+w5+w6+w7) lerp(
                                (w0+w1+w2+w3)/
(w0+w1+w2+w3+w4+w5+w6+w7)
                                lerp(
                                    (w0+w1)/(w0+w1+w2+w3),
                                    lerp(w0/(w0+w1), P0, P1),
                                    lerp(w2/(w2+w3), P2, P3)
                                  ),
                                lerp(
                                    (w4+w5)/(w4+w5+w6+w7),
                                    lerp(w4/(w4+w5), P4, P5),
                                    lerp(w6/(w6+w7), P6, P7)
                                  )
                                )
```

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor. While linear interpolation is described herein, other forms of interpolation can also be used.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
using a dedicated linear interpolation unit to calculate a dot product.

2. The method of claim 1 wherein using a dedicated linear interpolation unit includes using a texture unit.

3. The method of claim 1 wherein using a dedicated linear interpolation unit includes using a texture sampler.

4. The method of claim 1 wherein a dedicated linear interpolation unit includes using a graphics processor.

5. The method of claim 2 including offloading a dot product calculation from a general purpose processor to a texture unit.

6. The method of claim 1 including determining a convolution using said interpolation unit.

7. The method of claim 6 including using said convolution to display an image.

8. An apparatus comprising:
a processing entity;
a memory coupled to said processing entity;
an interpolation unit coupled to said processing entity; and
said interpolation unit to calculate a dot product.

9. The apparatus of claim 8 wherein said interpolation unit is a linear interpolation unit.

10. The apparatus of claim 8 wherein said linear interpolation unit includes a texture unit.

11. The apparatus of claim 9 wherein said linear interpolation unit is part of a graphics processor.

12. The apparatus of claim 8, said processing unit to offload a dot product calculation to a texture unit.

13. The apparatus of claim 8, said interpolation unit to determine a convolution.

14. The apparatus of claim 13, said interpolation unit to display an image.

15. A medium storing instructions for execution by a processing entity to:
determine that a dot product calculation is requested; and
offload said dot product to a dedicated linear interpolation unit.

16. The medium of claim 14 further calculating storing instructions to offload said dot product to a texture unit.

17. The medium of claim 15 further storing instructions to offload said dot product calculation to a graphics processor.

18. The medium of claim 16 further storing instructions to offload a dot product calculation from a general purpose processor to a texture unit.

19. The medium of claim 14 further storing instructions to determine a convolution using said interpolation unit.

20. The medium of claim 19 further storing instructions to use said convolution to display an image.
